(19) United States
(12) Patent Application Publication
(10) Pub. No.: US 2016/0107672 A1
(43) Pub. Date: Apr. 21, 2016

(54) ANTI-TIPPING STROLLER DEVICE

(71) Applicant: SCS DESIGNS LLC, Brooklyn, NY (US)

(72) Inventor: Sean SMITH, Brooklyn, NY (US)

(21) Appl. No.: 14/868,723

(22) Filed: Sep. 29, 2015

Related U.S. Application Data
(60) Provisional application No. 62/058,103, filed on Oct. 1, 2014.

(51) Int. Cl. B62B 9/12

(52) U.S. Cl. CPC B62B 9/12

(57) ABSTRACT

An anti-tipping/stand device for providing support for a stroller or similar device includes a clamp mechanism structured to be coupled to a portion of the stroller and a support system or “stand” portion selectively coupled to the clamp mechanism. The stand portion is selectively rotatable relative to the clamp mechanism among a plurality of positions for the user.

### CROSS-REFERENCE TO RELATED APPLICATIONS

The present application claims benefit of U.S. Provisional Application No. 62/058,103, filed Oct. 1, 2014, the disclosure of which is incorporated by reference herein in its entirety.

### BACKGROUND OF THE INVENTION

Strollers, especially lightweight easily compactable strollers—commonly termed as “umbrella strollers,” are generally not designed for any additional imposed loads on or around the handles. And as such it often takes a small load applied to the back of an empty stroller, and the stroller will topple over. Strollers can often be equipped with miscellaneous accessories and items including but not limited to: shopping bags, purses, diaper bags, coats, scooters, mounts for smart devices/tablets, cup holders, umbrella mounts etc. thereby easily imposing additional loads to the handles. Any occurrence of an imposed load is generally, temporarily stabilized by the occupant of the stroller acting as a counter weight, once the occupant exits, or is assisted exiting the stroller by the user, the stroller often destabilizes due to the additional loads now acting as a cantilever over the rear wheels and topples over along with the load imposing contents (diaper/shopping bags etc.)

### BRIEF SUMMARY OF THE INVENTION

In view of the foregoing disadvantages inherent in the light and compact designs of umbrella strollers, to take on additional imposed loads without tipping, the present invention provides an apparatus primarily developed for purposes to remain upright while sustaining said loads.

The anti-tipping stand, actuated by the user prior to the stroller occupant exiting the stroller, stabilizes and braces the stroller in place. The anti-tipping device hereinafter referred to as “stand” once actuated acts as a preventative measure to avoid the stroller from tipping over and allowing the stroller to remain in the open position with no further assistance from the user, while allowing miscellaneous load imposing items on and around the handlebars to remain in place for an indefinite amount of time on various terrains.

The present invention relates to an adjustable mounting device for securing an anti-tipping or weight supporting device/stand to a stroller, carriage, pram, wheelchair or other such device to provide stability from the imposed loads subject to the stroller or like device.

In one embodiment of the invention, a stand assembly for providing anti-tipping stability to a stroller or similar device is provided. The assembly includes a clamp mechanism structured to be coupled to a portion of the stroller and a stand portion selectively coupled to the clamp mechanism. The stand portion is selectively rotatable relative to the clamp mechanism among a plurality of positions.

The stand portion may be moveable among the plurality of positions while coupled to the clamp. The plurality of positions may comprise a first position in which the stand is structured to be positioned generally at a 60-80 degree angle to the ground. The clamp mechanism may comprise a first knob and a second knob, the first knob being structured to tighten or loosen the clamp mechanism from the stroller and the second knob being disposed to adjust the coupling of the stand portion and the clamp member. The stand portion may comprise an adjustable, collapsible, tethered, segmented cane (as shown in the illustrations here-in but certainly not limited to this design) another viable iteration would be a telescopin shaft, both in which would have a number of apertures disposed therein and the upper portion having a button member protruding radially therefrom for further height adjustment. The button member may be structured to engage a selected one of the number of apertures in a manner that allows for the relative positioning of the lower portion and the upper portion to be selectively adjusted.

In another embodiment of the invention, another shaft assembly for providing anti-tipping stability to a user parking a stroller or similar device is also provided. The assembly includes a stand having a telescoping shaft extending therefrom and a clamp mechanism having a first portion structured to be coupled to a portion of the stroller and a second portion coupled to the shaft of the stand. The second portion of the clamp mechanism is selectively rotatable about the first portion of the clamp mechanism such that the stand may be placed among a plurality of positions.

The second portion of the clamp mechanism may be selectively rotatable with respect to the first portion of the clamp mechanism from a first position to a second position. The first portion of the clamp mechanism may comprise a first lever that is structured to tighten or loosen the coupling of the first portion and the portion of the stroller. The second portion of the clamp mechanism may comprise a second knob member that is structured to control rotation of the second portion about the first portion. The second portion of the clamp mechanism may comprise an elbow or plastic arm that engages the telescoping stand. The plastic arm may comprise a number of apertures disposed therein and the telescoping stand may comprise a button member protruding radially therefrom, the button member being structured to selectively engage a selected one or of a number of apertures in a manner that allows for the relative positioning of the stand to be selectively adjusted.

It is to be understood that the invention is not limited in its application to the details of construction and to the arrangements of the components set forth in the following description or illustrated in the drawings and/or bi-tonal black and white pictures. The invention is capable of other embodiments and of being practiced and carried out in various ways. In regards to both the clamp and the stand and all related components there-in. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

These objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE SEVERAL VIEWS OF THE DRAWING

The foregoing and other features and advantages of the invention will become apparent upon reading the following detailed description of the invention in conjunction with the attached drawings in which:

FIGS. 1A-1C are side axonometric views of a non-limiting embodiment of the present invention installed on an example stroller with the anti-tipping device positioned in an active position.

FIG. 2 is a side elevational view of the embodiment of FIGS. 1A-1C separate from the stroller for clarity, with the stand portion assembled and positioned flat on its side and;

FIG. 3 is a side elevational view of the embodiment of FIG. 2 and with the stand portion collapsed in a stowed position; and

FIG. 4 is a bottom elevational view of the embodiment of FIG. 2 and with the stand portion collapsed in a stowed position; and

FIG. 5 is a side elevational view of the embodiment of FIG. 2 and with the stand portion collapsed in a stowed position; and

FIG. 6 is a top elevational view of the embodiment of FIG. 2 and with the stand portion collapsed in a stowed position; and

FIG. 7 is a user perspective view of the embodiment of FIG. 1 and with the stand portion assembled in a operable position; and

FIG. 8 is the embodiment of FIG. 7 and with a detailed view of how the stand is coupled to the clamp and how said clamp engages the stroller

FIG. 9 is a user perspective view of the embodiment of FIGS. 1A-1C and with the stand portion collapsed in a stowed position.

FIG. 10 is a perspective view of the embodiment of FIG. 2 and with detailed focus on the adjustable clamp.

FIG. 11 is an alternate perspective view of the embodiment of FIG. 2 and with detailed focus on the adjustable clamp.

FIG. 12 is a perspective view of the embodiment of FIG. 2 and with detailed focus on the junction elbow of where the clamp is coupled with the stand.

FIG. 13 is a perspective view of the embodiment of FIG. 2 and with detailed focus on the stand arm to clamp receiver arm in which forms the elbow and the various slotted apertures.

FIG. 14 is a perspective view of the embodiment of FIG. 2 and with detailed focus on the junction between the stand arm and the stand, and the various slotted apertures.

FIG. 15 is an exploded perspective view of the embodiment of FIG. 2 and with emphasis on the multiple components comprising the clamp

FIG. 16 is an exploded perspective view of the embodiment of FIG. 2 and with emphasis on the multiple apertures received by the clamp and provided by the clamp arm.

FIG. 17 is a perspective view of the embodiment of FIG. 2 and with emphasis on the tethered segmented stand joints in the collapsed position at the angle illustrating the foot and stand arm.

FIG. 18 is a perspective view of the embodiment of FIG. 2 and with emphasis on the tethered segmented stand joints in the collapsed position at the angle illustrating the middle sections of the stand.

All of the above figures are illustrating a device according to a non-limiting embodiment of the present invention.

### DETAILED DESCRIPTION OF THE INVENTION

As used herein, the singular form of “a”, “an”, and “the” include plural references unless the context clearly dictates otherwise. As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other.

As used herein, the word “unitary” means a component is created as a single piece or unit. That is, a component that includes pieces that are created separately and then coupled together as a unit is not a “unitary” component or body. As employed herein, the statement that two or more parts or components “engage” one another shall mean that the parts exert a force against one another either directly or through one or more intermediate parts or components. As employed herein, the term “number” shall mean one or an integer greater than one (i.e., a plurality).

Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

In addressing the overturning stroller issue, embodiments of the present invention provide a mounting device that attaches securely and easily to a stroller, carriage, pram, walker, wheelchair or other pushchair. As employed herein, the term “stroller” shall be used to mean a stroller, carriage, pram, walker, wheelchair or other similar device.

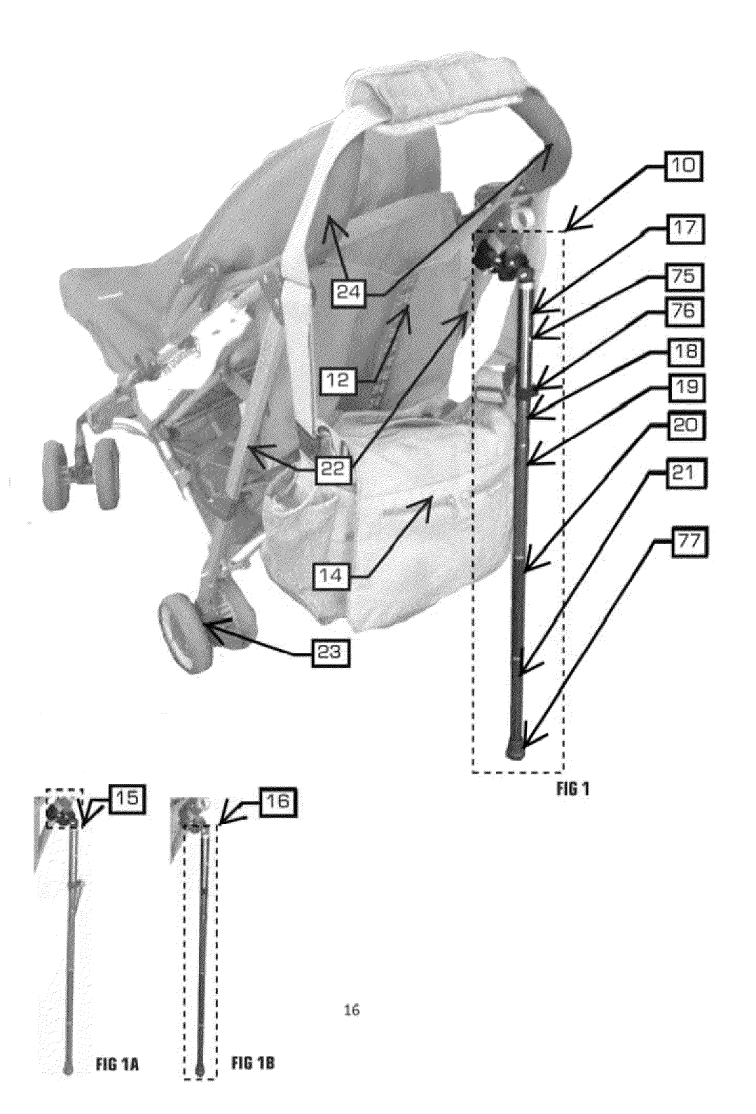

Referring to the bi-tonal pictures, FIG. 1C depicts an anti-tipping stroller device according to a non-limiting embodiment of the present invention, generally designated with the reference numeral 10, attached to a conventional folding or collapsible stroller otherwise referred to as an “umbrella stroller” 12. The stroller 12 seats a young child (not shown) who may be acting as a counterweight to the diaper bag 14 or other accessory or miscellaneous stored item (not shown). The anti-tipping device assembly 10, which may also attach to a pram, baby carriage, wheelchair, or other suitable device, includes a clamp 15, and a stand 16 (see FIG. 1A,1B). The stand, in the illustrated iteration, includes multiple segmented shafts 17,18, 19, 20, 21 includes an upper adjustable, sliding section 17 with suitably 5 holes (though more or less holes can be utilized), that receives and slides over shaft section 18 which is fashioned with a corresponding spring pin 75 that is intended to spring into said holes and lock the stand into positions of varying heights. Following shaft sections 17 and 18 and commencing where shaft section 18 meets shaft section 19 and so on through the subsequent shaft sections, is a rope comprised of elastic/nylon 80, tethering all shaft sections together. And in which, thereby, actuates a propensity for the stand to interlock and remain erect and upright in the locked position, once the velcro strap 76 is undone. The first few inches of the shaft sections are depressed 81 and of a smaller diameters, to be received by the last few inches of the adjoining shaft section which is thereupon fashioned with a flared and beveled edge 82 acting as a guide for all intermediate sections 18-20 as well as the lower section 21 to come together as a unit, section 21 will be fashioned with a rubber shoe or foot 77. Upper section 17 is coupled to a clamp 15 that attaches to a portion of the stroller frame 22 of the stroller 12, preferably proximal to the handle portion 24, in this case high on the back vertical leg 22 supporting the rear wheels 23 by a clamping mechanism 15 as shown in FIGS. 10,11. The clamping mechanism is described in further detail below.

Having thus described an overview of an example embodiment of an anti-tipping device 10 according to an embodiment of the invention, an example embodiment of a clamping mechanism 15 will now be described in conjunction with the FIGS., particularly in conjunction with the exploded view of FIG. 15,16. The example clamping mechanism 15 of FIG. 15,16 serves two general functions: first it serves to couple the stand 16 to stroller 12, and second it serves to allow for the adjustment of the relative positing of the stand 16 with respect to stroller 12.

In providing the first function, clamping mechanism 15 includes a first clamp member 30 having a threaded shaft 32 extending through a portion thereof such that a first end 34 with affixed capped lock nut, of threaded shaft 32 protrudes from a first side of clamp member 30, and an opposite second end 36 protrudes from an opposite second side of clamp member 30. A second clamp member 38 includes a pivot pin 40 that interlocks with a corresponding portion of first clamp member 30, creating a hinge point that allows the two clamp members 30, 38 to cooperatively engage, and be tightened, on a selected portion of the stroller 12, preferably at or near the handle portion 24. The two clamp members 30, 38 are tightened by turning a stroller tightening lever 42 threadedly disposed on threaded shaft 32 at or near second end 36. A truss rod anchor nut 48 is preferably installed in the tightening lever 42 during manufacturing and a washer 44 is sandwiched between stroller lever 42 and clamp member 38. There is an additional corresponding truss rod anchor 41 integrated into clamp member 30 that will be the opposing communication transposed through the threaded shaft 32 and allowing the clamp members 30, 38 to expand and contract relative to one another. Preferably, such elements are made from a composite material such as reinforced polycarbonate, EPS (or other type of composite) or other suitable material. In use, the tightening lever 42 opens and closes the clamp formed by the first and second clamp members 30, 38 to secure the anti-tipping device 10 to the stroller 12. Preferably, the tightening knob 42 is manufactured to only loosen a selected amount, and thus cannot be removed from the threaded shaft via cap nut 34 and epoxy or latex coating applied to the last few threads of 36 to avoid the potential over loosening by a user.

Preferably, one or both of clamp members 30, 38 are provided with a number of generally small grip protrusions 50 molded into the concave clamp area (not numbered) thereof. The grip protrusions 50 allow the clamp formed by the first and second clamp members 30, 38 to grip the cushioned (rubber, foam, plastic or metal) handles or other selected portion of a stroller.

In providing the second function, clamping mechanism 25 includes rotating positioning knob 60 with multiple notched apertures radially configured around a perimeter component 55 and to be received by, and coupled to relative apertures located in a radial depression with corresponding apertures 53 on the back of clamp member 38 via self-tapping screw 65, washer 66 and spring 67. Thereby allowing positioning knob 60 to rotate freely about clamp member 38 and lock into integral positions about the axis with minimal exertion from the user.

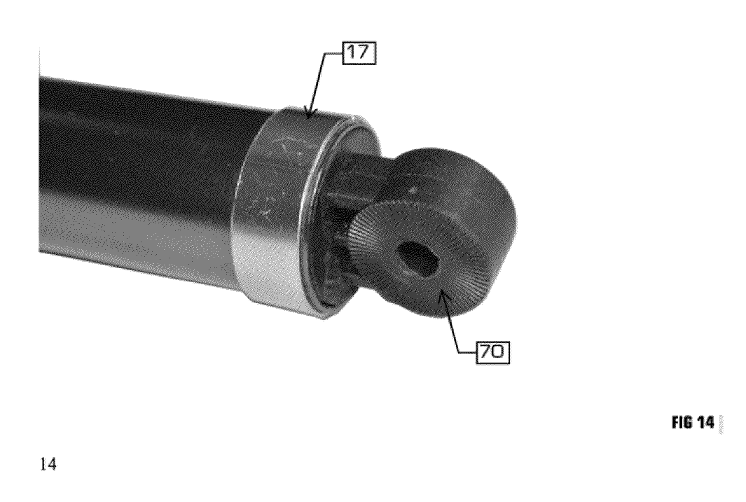

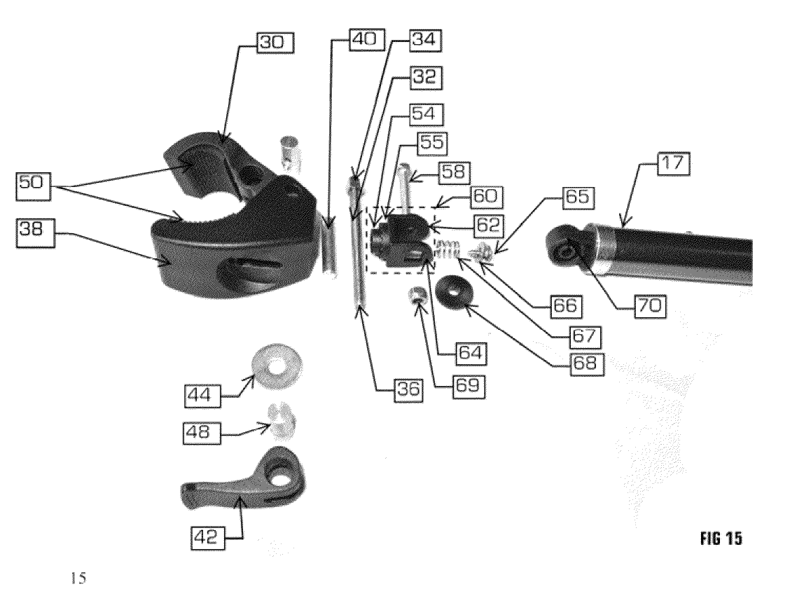

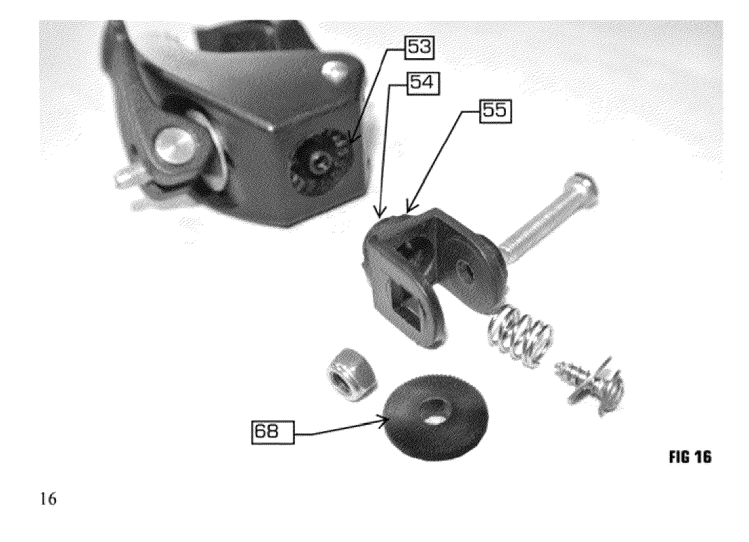

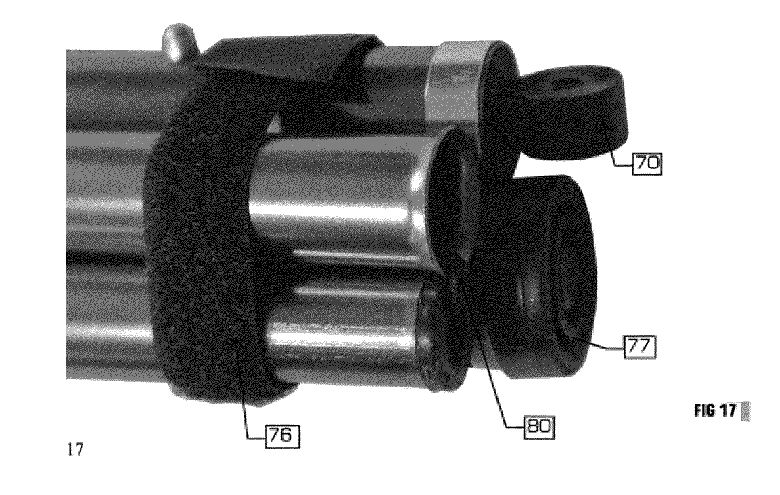

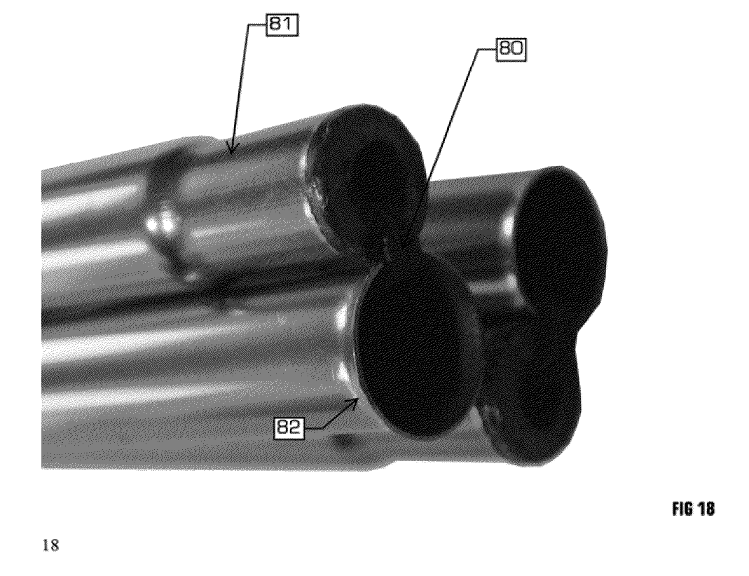

Ribbed receiving disc 68 has an integral square washer to allow it to align with winged appendage 64 and affix into position via hexagonal screw head with corresponding profile located on winged appendage 61. Hexagonal screw thread 58 then precedes through stand arm 70, through ribbed receiving disc 68 and corresponding appendage 64 and engage locknut 69. Thereby, allowing the stand arm 70 (or anything attached thereto) to further rotate about axis 58 which would in turn effect the angle of the stand relative to the position of the stroller. Where the relationship of the stand 71 to the positioning knob 60 is of the utmost importance as its typically related to holding the stroller in the upright position, the multiple pluralities derived from the relationship between the positioning knob 60 and clamp member 38 is of subordinate importance as it conveniently allows the user to position the foot of the stand in more relevant orientations relative to the terrain and/or to better counter the perhaps unevenly distributed weight of the contents imposed on the stroller 12. The ability to have two means of rotating arms allows for the versatility in gripping the various types of stroller conditions that will present themselves through the application of design. Stand arm 70 is fixedly engaged to item 71 during manufacturing see FIG. 14.

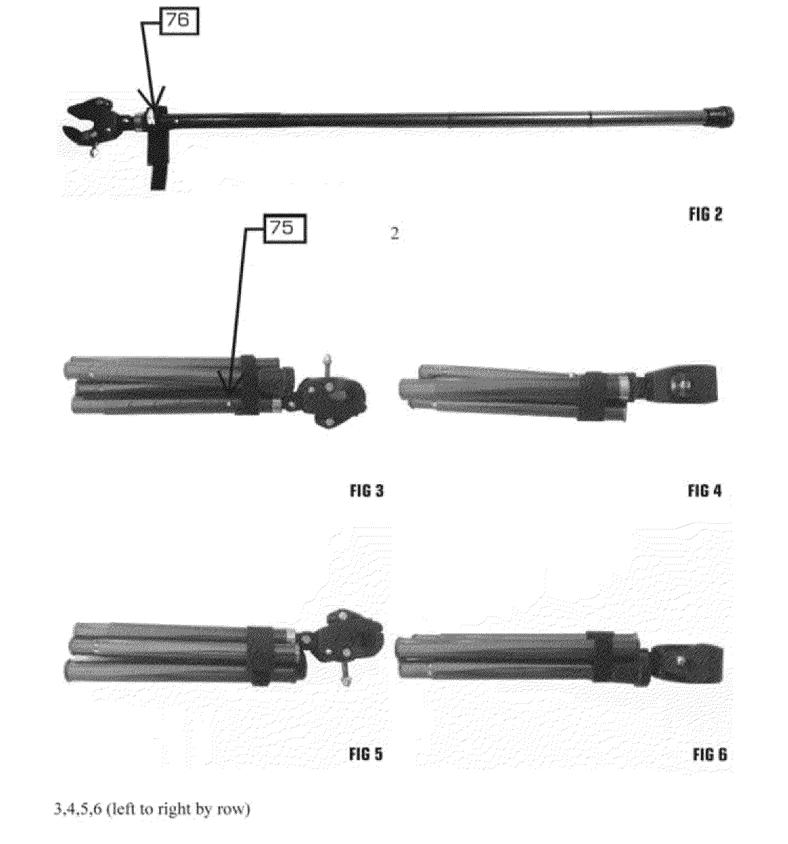

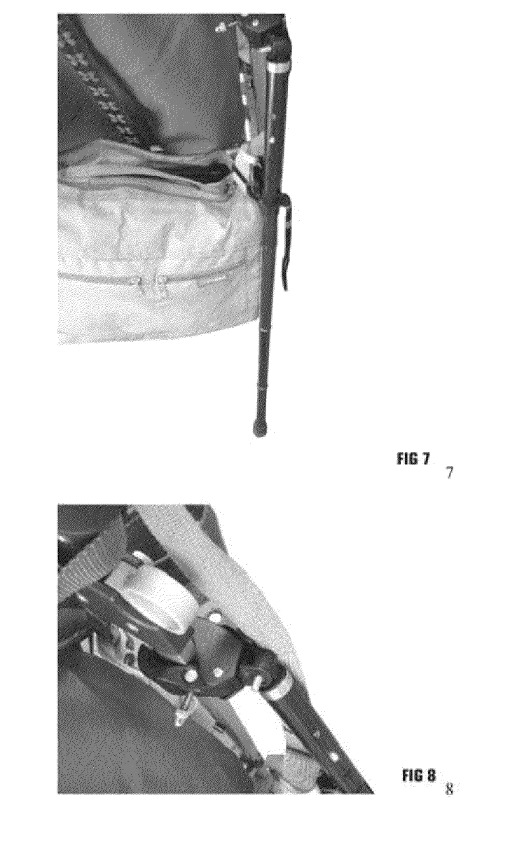

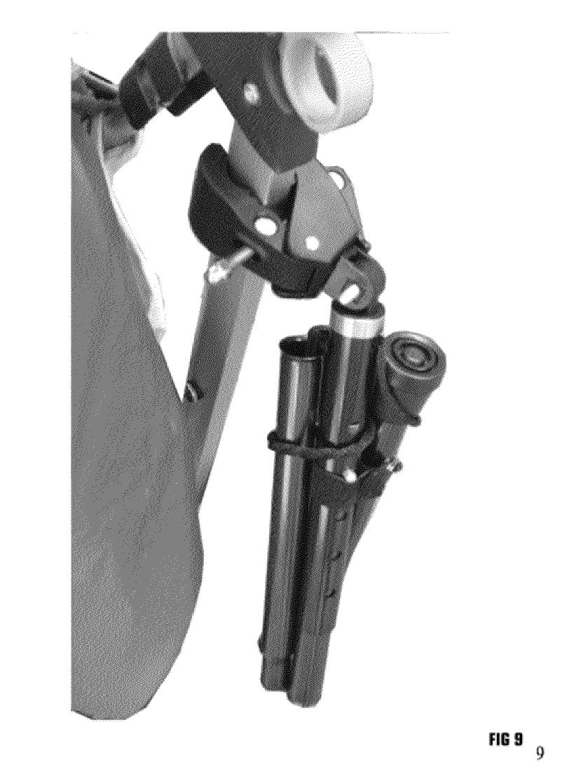

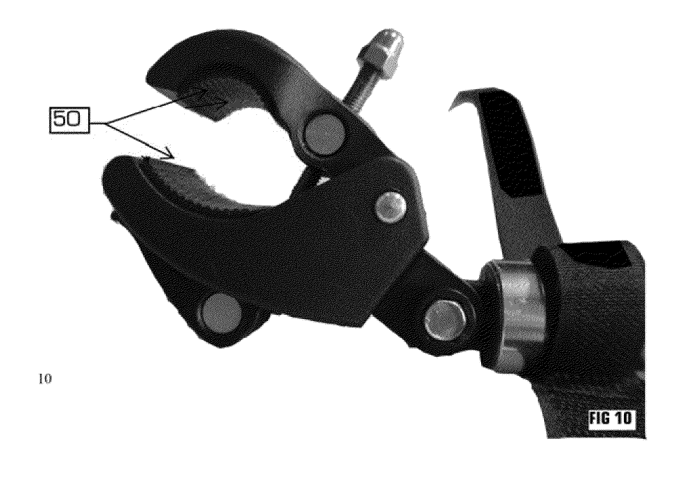

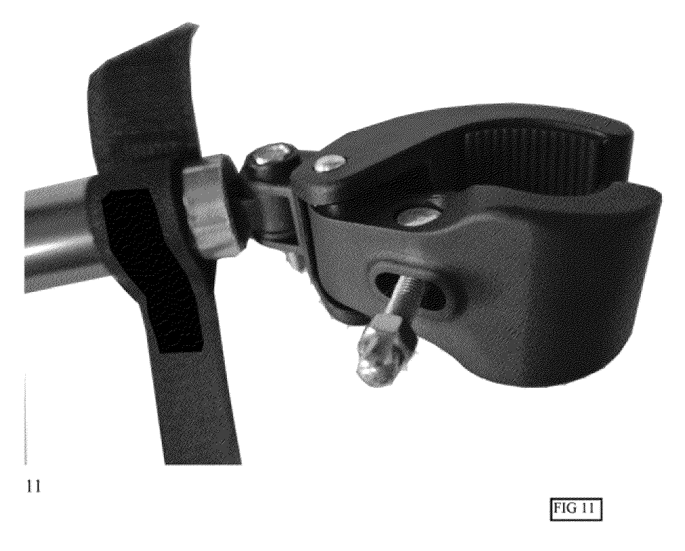

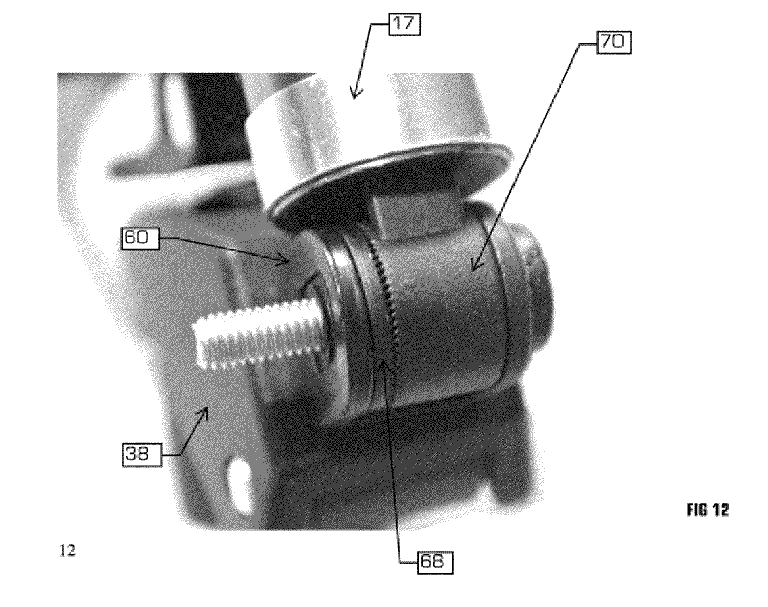

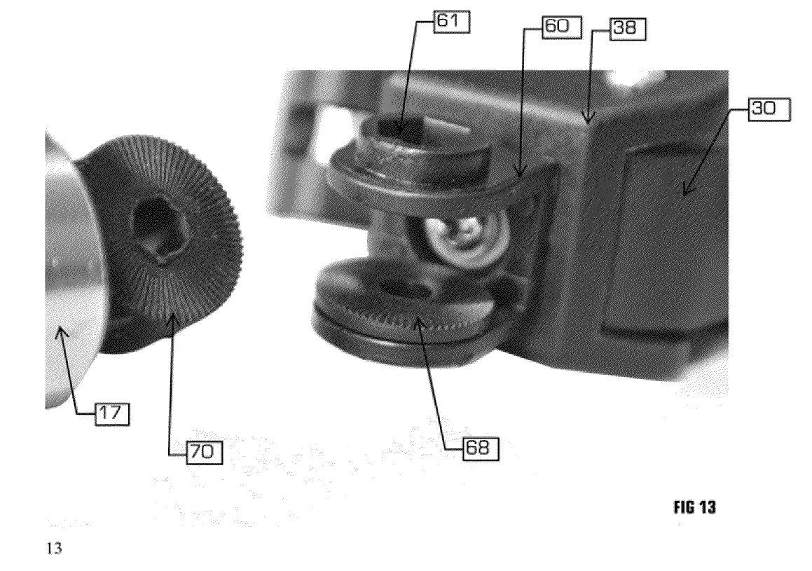

As shown in FIGS. 2-6,11 and 17, the securing of the adjustable stand segments occurs via a velcro strap or the like 75 and acts in keeping the stand collapsed and stowed and out of the users way. Ideally, this would occur while also securing the stand 10 to the stroller rear vertical leg 22 of the stroller.

It should be appreciated that an anti-tipping device attaches to a stroller to resist overturning from additional imposed loads, as it pertains to common everyday use and practice, has been described, with reference to preferred embodiments illustrated in the accompanying drawings, but that other modifications may be made to this preferred embodiment. It will be appreciated that the present invention is not limited to those precise embodiments, and that various changes and modifications may be made thereto by one of ordinary skill in the art without departing from the scope or spirit of the invention, which is defined in the following claims.

What is claimed is:

1. An anti-tipping stroller device comprising:
an adjustable walking cane having two or more segmented and collapsible sections held together by an internal rope, the cane portion comprising a button member protruding radially therefrom; and
a clamp mechanism having a first portion structured to be coupled to a portion of the stroller and a second portion that engages the cane,
wherein the first portion of the clamp mechanism includes a tightening knob that is structured to tighten or loosen the coupling of the first portion and the portion of the stroller, the tightening knob being rotatable about an axis extending through the first and second portions of the clamp mechanism,
wherein the second portion of the clamp mechanism is selectively rotatable about the axis extending through first and second portions of the clamp mechanism, wherein the second portion of the clamp mechanism includes a control mechanism to control the rotation of the second portion about the first portion,
wherein the rotating arm comprises a plurality of apertures disposed therein, each of the apertures being selectively engage able by the radial angled slots allotted on the rotating arm.

2. The anti-tipping stroller device of claim 1, wherein the button member both releases and drops the cane into an operable and locked assembled position, as well as disengages a locking mechanism to collapse or telescope back into itself.

3. The anti-tipping stroller device of claim 1, further comprising a positionable foot at the bottom of the cane, wherein the foot comprises metal or rubber.

4. The anti-tipping stroller device of claim 1, wherein the control mechanism of the clamp mechanism further comprises of an additional clamp, which can secure multiple pivoting positions.

5. The anti-tipping stroller device of claim 1, further comprising a mechanism for stowing the cane selected from the group of a strap, a magnet and Velcro.

6. The anti-tipping stroller device of claim 1, wherein the clamp mechanism is a spring loaded clamp in the closed position.
